(19) United States
(12) Patent Application Publication
(10) Pub. No.: US 2007/0189308 A1
(43) Pub. Date: Aug. 16, 2007

(54) Virtual machine networking using wireless bridge emulation

(76) Inventors: Izoslav Tchigevsky, Kiryat Haim (IL); Omer Ben-Shalom, Rishon (IL)

Correspondence Address: SCHWEGMAN, LUNDBERG, WOESSNER & KLUTH, P.A., P.O. BOX 2938, MINNEAPOLIS, MN, 55402, US

(21) Appl. No.: 11/355,829

(22) Filed: Feb. 16, 2006

(51) Int. Cl. H04L 12/56

(52) U.S. Cl. 370/396

(57) ABSTRACT

Embodiments of multi-partition virtual machine networking mechanisms are described generally herein. Other embodiments may be described and claimed.

### TECHNICAL FIELD

Various embodiments described herein relate to digital communications generally, including apparatus, systems, and methods used in wireless networking.

### BACKGROUND INFORMATION

A modern computing platform may be multi-partitioned. That is, two or more execution environments may coexist on the computing platform. Each execution environment may utilize some or all of the same platform resources as the other execution environment(s), and may be unaware of the existence of the others. These attributes may be referred to collectively as “virtualization” of the platform resources. An execution environment associated with a particular partition may be referred to as a “virtual machine” (VM).

For corporate networks it is desirable that each VM be capable of communicating with the networking infrastructure at a media access control (MAC) layer, also known as layer 2 (L2). This enables a corporate network administrator to enforce certain security and traffic priority policies for a variety of computers and computer users. In order to maintain network communications at L2, a VM may maintain its own network stack independent of a network stack maintained by another partition.

One approach to wireless VM networking is to dedicate a separate wireless interface to each VM partition. Using such approach, the computing platform may appear to a wireless access point (AP) as two or more independent stations. Duplication of wireless networking resources may be especially costly, though, considering hardware and maintenance costs and increased consumption of spectral resources.

### BRIEF DESCRIPTION OF THE DRAWINGS

FIG. 1 is a block diagram of an example apparatus and a representative system according to various embodiments.

FIG. 2 is a block diagram of another example apparatus according to various embodiments.

FIG. 3 is a flow diagram illustrating several methods according to various embodiments.

FIG. 4 is another flow diagram illustrating several methods according to various embodiments.

FIG. 5 is a block diagram of an article according to various embodiments.

### DETAILED DESCRIPTION

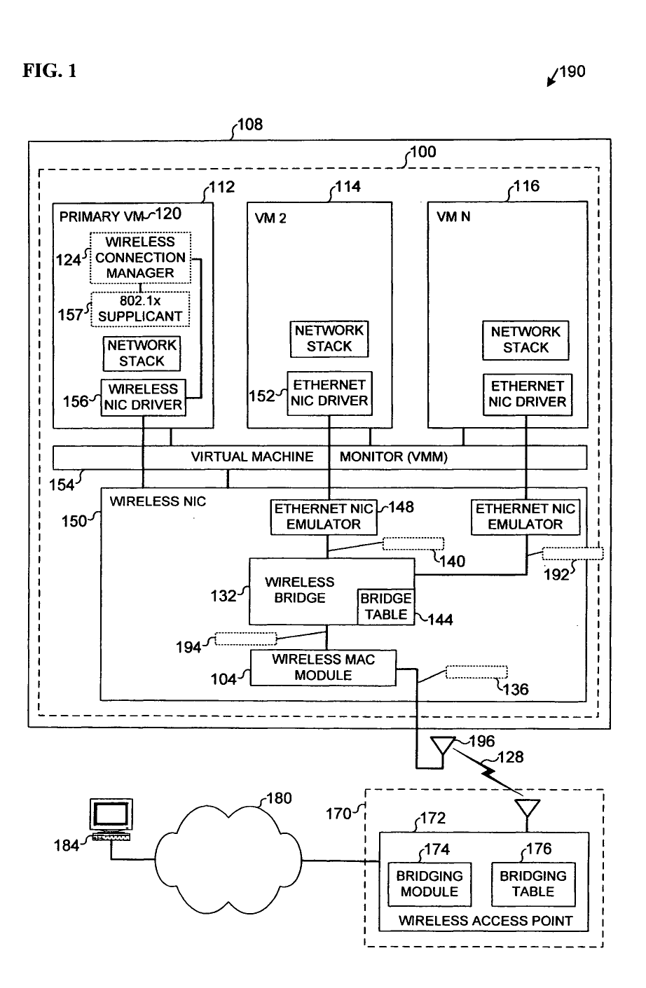

FIG. 1 comprises a block diagram of an apparatus 100, an apparatus 170, and a system 190 according to various embodiments of the invention. The apparatus 100 may comprise structures within a multi-VM computing platform 108 used to enable wireless networking to a plurality of partitions within the computing platform 108. The apparatus 170 may comprise a wireless AP specially adapted to enable the wireless networking to the plurality of partitions.

The apparatus 100 may include a wireless MAC module 104 associated with a multi-VM computing platform 108. The wireless MAC module 104 may communicate with a wireless AP 172 attached to a network 180 external to the computing platform 108. The network 180 may comprise any packet-switched network, including a local area network, a personal area network, or a corporate network, without limitation, or any of these connected to the Internet. The apparatus 100 may incorporate capabilities of a wireless bridge. The wireless bridging capabilities may facilitate networking for a plurality of VMs, generally shown as 112, 114, and 116, associated with the computing platform 108. The plurality of VMs 112, 114, and 116 is exemplary. Embodiments herein may comprise a greater or lesser number of VM partitions. The terms “VM” and “VM partition” are used synonymously herein.

In some embodiments, one of the VMs 112, 114, or 116 may be defined as a primary VM 120. A wireless connection manager 124 may execute from the primary VM 120 to control a wireless connection 128. The wireless connection manager 124 may operate in a similar way as a non-virtualized wireless connection manager. That is, a user may choose connection profiles, select APs, enable security settings, and view wireless signal strength, among other wireless connection management functions. Alternatively, the wireless connection manager 124 may have no user interface in some embodiments, and the wireless connection 128 may be established without user involvement. In either case, a MAC address and security credentials associated with the wireless connection 128 may be defined by the wireless connection manager 124 executing in the primary VM 120.

VMs other than the primary VM 120 (e.g., VMs 114 and 116) may be connected to the network 180 using wireless bridge emulation. The VMs 114 and 116 may not recognize that the computing platform 108 is wirelessly networked, but may instead interact with a wireless bridge 132 via an Institute of Electrical and Electronics Engineers (IEEE) 802.3 (Ethernet) standard networking interface. Additional information regarding the IEEE 802.3 standard may be found in “802.3™ IEEE Standard for Information technology—Telecommunications and information exchange between systems—Local and metropolitan area networks—Specific requirements—Part 3: Carrier sense multiple access with collision detection (CSMA/CD) access method and physical layer specifications” (published 2002).

In order to simulate wireless bridge behavior, the wireless bridge 132, the wireless MAC module 104, and the wireless AP 172 may interoperate to implement a wireless bridge frame format in accordance with the IEEE 802.11 family of standards. That is, data packets may be sent with both a “to distribution system” (DS) bit and a “from DS” bit set to 1. Wireless MAC address fields associated with the DS format may be implemented as follows:

From AP to Station (Inbound Packets):
Address 1—receive address (RA)—MAC address of the wireless MAC module 104.
Address 2—transmit address (TA)—MAC address of the wireless AP 172.
Address 3—destination address (DA)—MAC address of a destination VM associated with the computing platform 108 (e.g., the VM 114).
Address 4—source address (SA)—MAC address of a source node on the network 180 (e.g., a node 184).

From Station to AP (Outbound Packets):
Address 1—RA—MAC address of the wireless AP 172.
Address 2—TA—MAC address of the wireless MAC module 104.
Address 3—DA—MAC address of a destination node on the network 180 (e.g., the node 184).
Address 4—SA—MAC address of a source VM associated with the computing platform 108 (e.g., the VM 114).
   Additional information regarding the IEEE 802.11 standard may be found in “ANSI/IEEE Std. 802.11, Information technology—Telecommunications and information exchange between systems—Local and metropolitan area networks—Specific requirements—Part 11: Wireless LAN Medium Access Control (MAC) and Physical Layer (PHY) Specifications” (published 1999; reaffirmed June 2003).

The apparatus 100 may include the wireless MAC module 104, as previously described. The wireless MAC module 104 may receive an inbound wireless packet 136. The inbound wireless packet 136 may be formatted according to the IEEE 802.11 standard, perhaps as a wireless DS packet comprising a receiver address and a destination address.

The apparatus 100 may also include the wireless bridge 132. The wireless bridge 132 may be coupled to the wireless MAC module 104 to receive the inbound wireless packet 136. The wireless bridge 132 may convert the inbound wireless packet 136 to an inbound Ethernet packet 140. The inbound Ethernet packet 140 may be formatted to contain the destination address, wherein the destination address corresponds to the destination VM (e.g., the VM 114).

The wireless bridge 132 may perform a lookup operation to retrieve a VM partition identifier using a bridging table 144. The lookup operation may use the destination address to index the VM partition identifier from the bridging table 144. The wireless bridge 132 may then send one or more portions of the inbound Ethernet packet 140 to the destination VM corresponding to the destination address (e.g., the VM 114).

The apparatus 100 may further include an Ethernet NIC emulator 148 coupled to the wireless bridge 132 and associated with the destination VM (e.g., the VM 114). The Ethernet NIC emulator 148 may deliver the portion(s) of the inbound Ethernet packet 140 to an Ethernet NIC driver 152 associated with the destination VM (e.g., the VM 114).

A virtual machine monitor (VMM) 154 may be coupled to the Ethernet NIC emulator 148, the wireless bridge 132, or both, to allocate Ethernet emulation resources to the destination VM partition (e.g., the VM 114). In some embodiments, wireless bridging components including the wireless MAC module 104, the wireless bridge 132, and the Ethernet NIC emulator 148 may be incorporated into a wireless NIC 150 associated with the multi-partition computing platform 108.

A wireless NIC driver 156 may be associated with the primary VM partition 120. The wireless NIC driver 156 may be coupled to the wireless MAC module 104. The wireless NIC driver 156 may communicate data, status, and/or configuration parameters between the primary VM partition 120 and the wireless MAC module 104.

The wireless connection manager 124 may also be associated with the primary VM partition 120, as previously described. The wireless connection manager 124 may be coupled to the wireless NIC driver 156, and may be used to configure the wireless NIC 150 and to receive and report status from the wireless NIC 150. A security supplicant 157 (e.g., an IEEE std. 802.1X supplicant) may be coupled to the wireless connection manager 124 to exchange encryption keys with the wireless AP 172 to facilitate secure wireless communications. Additional information regarding the IEEE std. 802.1X may be found in “802.1X™ IEEE Standard for Local and metropolitan area networks—Port-based Network Access Control” (published Dec. 13, 2004).

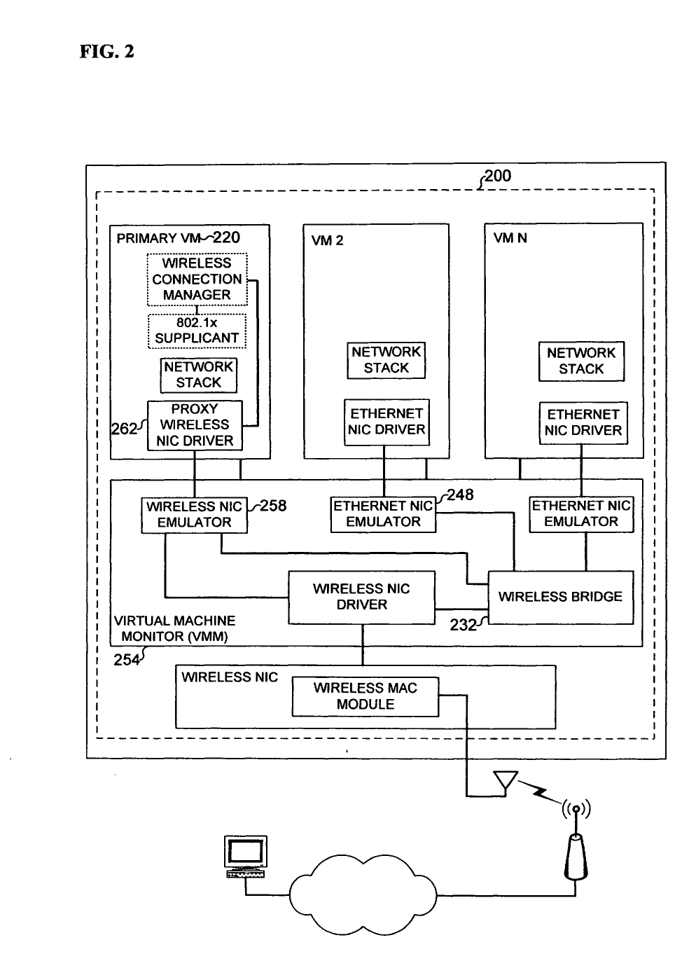

FIG. 2 comprises a block diagram of an alternate embodiment 200 of the apparatus 100. The alternate embodiment 200 may include structures associated with the apparatus 100, as previously described. In the alternate embodiment 200, a VMM 254 may include a wireless bridge 232 and an Ethernet NIC emulator 248. The VMM 254 may further include a wireless NIC emulator 258. The wireless NIC emulator 258 may be coupled to a proxy wireless NIC driver 262 associated with a primary VM 220. The wireless NIC emulator 258 may interface the primary VM 220 to wireless structures within the VMM 254.

In another embodiment, the primary VM 220 and the VMM 254 may not include the proxy wireless NIC driver 262 and the wireless NIC emulator 258, respectively. Rather, the primary VM 220 may interface to the VMM 254 via an Ethernet NIC driver in the primary VM 220 and an Ethernet NIC emulator in the VMM 254, as previously described generally using the VM 114 and the VMM 116 of FIG. 1 as examples.

Turning back to FIG. 1, an apparatus 170 may include a wireless AP 172 communicatively coupled to a wireless NIC 150 associated with a multi-partitioned computing platform 108. The wireless AP 172 may send an inbound packet 136 to the wireless NIC 150 for delivery to a destination VM (e.g., the VM 114) associated with the multi-partitioned computing platform 108.

The apparatus 170 may also include a bridging module 174 associated with the wireless AP 172. A bridging table 176 may be coupled to the bridging module 174. The bridging table 176 may associate a receiver address with a destination address contained in the inbound wireless packet 136. The receiver address may be associated with the wireless NIC 150. The destination address may be associated with a destination VM (e.g., the VM 114). The bridging module 174 may insert the receiver address into the inbound wireless packet 136 in order to convert the inbound wireless packet 136 to a DS format.

In another embodiment, a system 190 may include one or more of the apparatus 100, the apparatus 170, or both, in any combination of the embodiments previously described. The system 190 may include a wireless bridge 132 associated with a multi-partitioned computing platform 108. The wireless bridge 132 may be configured to receive an outbound Ethernet packet 192 from an originating VM (e.g., the VM 116). The wireless bridge 132 may convert the outbound Ethernet packet 192 to an outbound wireless packet 194. The outbound wireless packet 194 may be formatted as a wireless DS packet.

A wireless MAC module 104 may be coupled to the wireless bridge 132 to send the outbound wireless packet 194 to a wireless AP 172 for delivery to a node 184 on an external network 180. The system 190 may also include an antenna 196 coupled to the wireless MAC module 104. The antenna 196 may communicatively couple the wireless MAC module 104 to the wireless AP 172. The antenna 196 may comprise a patch, omnidirectional, beam, monopole, or dipole, among other types.

Any of the components previously described can be implemented in a number of ways, including embodiments in software. Thus, the apparatus 100; the wireless MAC module 104; the multi-VM computing platform 108; the wireless AP 172; the network 180; the virtual machines (VMs) 112, 114, 116, 120, 220; the wireless connection manager 124; the wireless connection 128; the wireless bridges 132, 232; the node 184; the inbound wireless packet 136; the inbound Ethernet packet 140; the bridging table 144; the Ethernet NIC emulators 148, 248; the Ethernet NIC driver 152; the VMMs 154, 254; the wireless NIC 150; the wireless NIC driver 156; the security supplicant 157; the proxy wireless NIC driver 162; the apparatus 170; the bridging module 174; the bridging table 176; the system 190; the outbound Ethernet packet 192; the outbound wireless packet 194; the antenna 196; the alternate embodiment 200; the wireless NIC emulator 258; and the proxy wireless NIC driver 262 may all be characterized as “modules” herein.

The modules may include hardware circuitry, single or multi-processor circuits, memory circuits, software program modules and objects, firmware, and combinations thereof, as desired by the architect of the apparatus 100 and 170, and of the system 190, and as appropriate for particular implementations of various embodiments.

The apparatus and systems of various embodiments may be useful in applications other than delivering a wireless traffic stream addressed to one of a plurality of VMs in a multi-partitioned computing platform. Thus, various embodiments of the invention are not to be so limited. The illustrations of the apparatus 100 and 170, and of the system 190, are intended to provide a general understanding of the structure of various embodiments. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., mp3 players), vehicles, medical devices (e.g., heart monitor, blood pressure monitor, etc.) and others. Some embodiments may include a number of methods.

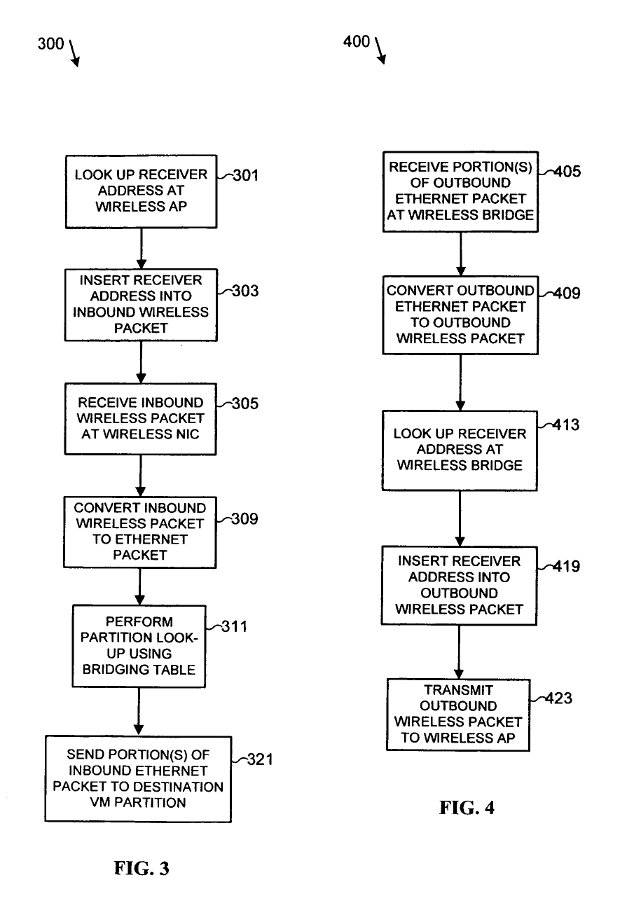

FIG. 3 is a flow diagram illustrating several methods according to various embodiments. A method 300 may comprise activities associated with a multi-partitioned computing platform communicatively coupled to a wireless AP. The wireless AP may be communicatively coupled to a network external to the computing platform.

The method 300 may commence at block 301 with looking up a receiver address at the wireless AP upon receipt of a wireless packet inbound to the computing platform. The receiver address may correspond to an address associated with a wireless NIC at the computing platform. The wireless AP may be adapted to perform a look-up of the receiver address from a wireless bridging table associated with the wireless AP. The bridging table may relate the receiver address to a plurality of destination addresses. Each destination address may correspond to one of a plurality of VM partitions associated with the multi-partitioned computing platform. The method 300 may include inserting the receiver address into the inbound wireless packet to form a wireless DS packet, at block 303. In one example, the wireless AP 172 of FIG. 1 (e.g., via the bridging module 174 and the bridging table 176) may identify a receiver address associated with the wireless NIC 150. Following the above example with reference to FIG. 1, the wireless AP 172 may transmit a wireless DS packet including the receiver address associated with the wireless NIC 150. The wireless DS packet may be transmitted to the computing platform 108 via the wireless connection 128.

The method 300 may also include receiving the inbound wireless packet (i.e., the wireless DS packet) at the wireless NIC, at block 305. The method 300 may continue at block 309 with converting the inbound wireless packet to an inbound Ethernet packet formatted to contain the destination address. The conversion may be performed by a wireless bridge within the computing platform. The method 300 may also include performing a look-up operation using a bridging table associated with the wireless bridge, at block 311. The look-up operation may determine which of the plurality of VM partitions comprises a destination VM partition corresponding to the destination address.

The method 300 may conclude with sending one or more portions of the inbound Ethernet packet to the destination VM partition corresponding to the destination address, at block 321. The portion(s) of the inbound Ethernet packet may be sent from the wireless bridge to a destination Ethernet NIC driver associated with the destination VM partition. The destination Ethernet NIC driver may be associated with a destination network stack in the destination VM partition.

FIG. 4 is a flow diagram illustrating several methods according to various embodiments. A method 400 may commence at block 405 with receiving one or more portions of an outbound Ethernet packet at a wireless bridge associated with a multi-partitioned computing platform. The portion(s) of the outbound Ethernet packet may be received from an originating VM partition, and may contain a source address corresponding to the originating VM partition. In one example, the outbound Ethernet packet 192 of FIG. 1 may be received at the wireless bridge 132 from the VM partition 114 associated with the computing platform 108.

The outbound Ethernet packet may also contain a destination address corresponding to a node on a network external to the computing platform. (E.g., the node 184 of FIG. 1 on the network 180.) In some embodiments, the portion(s) of the outbound Ethernet packet may be received from an originating Ethernet NIC driver associated with an originating network stack in the originating VM partition. (E.g., the portions of the outbound Ethernet packet 192 of FIG. 1 may be received from the Ethernet NIC driver 152 associated with the network stack of the VM 114.)

The method 400 may continue at block 409 with converting the outbound Ethernet packet to an outbound wireless packet. The wireless bridge may perform the conversion. The outbound wireless packet may be formatted as a wireless DS packet, and may contain a transmitter address corresponding to an address associated with a wireless NIC. The method 400 may also include performing a look-up of a receiver address, at block 413. The receiver address may correspond to a wireless AP (e.g., the wireless AP 172 of FIG. 1) communicatively coupled to the computing platform. The method 400 may further include inserting the receiver address into the outbound wireless packet, at block 419.

The outbound wireless packet may thus contain a receiver address associated with the wireless AP, a source address corresponding to the originating VM partition, and a destination address corresponding to the node on the external network. The method 400 may conclude at block 423 with transmitting the outbound wireless packet from the wireless NIC to the wireless AP. It is noted that in some embodiments, activities associated with blocks 413 and 419 may be omitted. In the latter case, the outbound wireless packet may be sent to the wireless AP in a non-DS format.

It may be possible to execute the activities described herein in an order other than the order described. And, various activities described with respect to the methods identified herein can be executed in repetitive, serial, or parallel fashion.

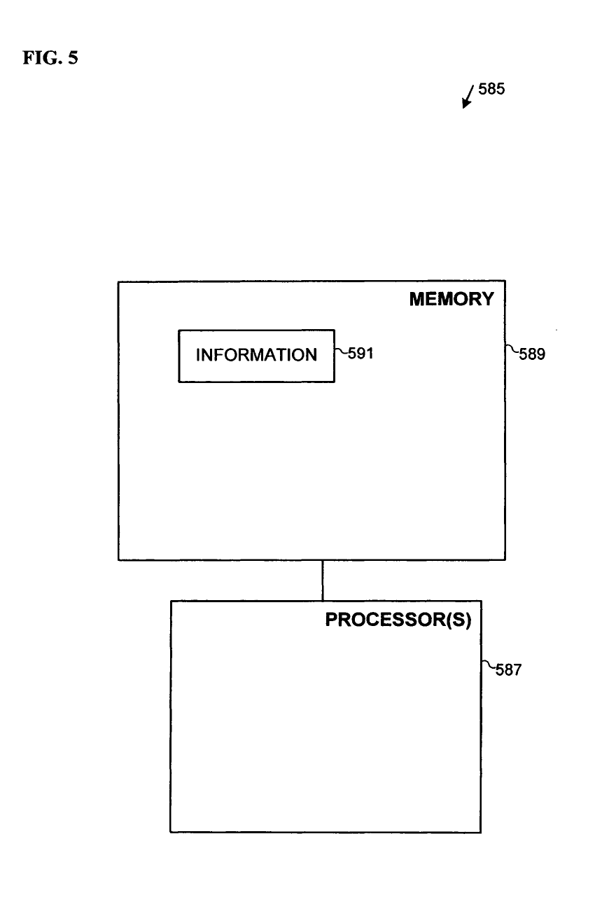

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment. Thus, other embodiments may be realized, as discussed regarding FIG. 5 below.

FIG. 5 is a block diagram of an article 585 according to various embodiments of the invention. Examples of such embodiments may comprise a computer, a memory system, a magnetic or optical disk, some other storage device, or any type of electronic device or system. The article 585 may include one or more processor(s) 587 coupled to a machine-accessible medium such as a memory 589 (e.g., a memory including electrical, optical, or electromagnetic elements). The medium may contain associated information 591 (e.g., computer program instructions, data, or both) which, when accessed, results in a machine (e.g., the processor(s) 587) performing the activities previously described.

Implementing the apparatus, systems, and methods disclosed herein may connect multiple VMs executing on the same computing platform to a wireless network. The connection may be made using a single wireless NIC while preserving an independent MAC-level connection of each VM to a network infrastructure associated with the wireless network. This connectivity may be achieved without involving partitions, other than perhaps a primary partition, in wireless networking configuration or management.

Although the inventive concept may include embodiments described in the exemplary context of an IEEE standard 802.xx implementation (e.g., 802.11, 802.11a, 802.11b, 802.11E, 802.11g, 802.16, etc.), the claims are not so limited. Additional information regarding the IEEE 802.11a protocol standard may be found in IEEE std. 802.11a, Supplement to IEEE Standard for Information technology—Telecommunications and information exchange between systems—Local and metropolitan area networks—Specific requirements Part 11: Wireless LAN Medium Access Control (MAC) and Physical Layer (PHY) specifications—High-speed Physical Layer in the 5 GHz Band (published 1999; reaffirmed Jun. 12, 2003). Additional information regarding the IEEE 802.11b protocol standard may be found in IEEE std. 802.11b, Supplement to IEEE Standard for Information technology—Telecommunications and information exchange between systems—Local and metropolitan area networks—Specific requirements—Part 11: Wireless LAN Medium Access Control (MAC) and Physical Layer (PHY) specifications: Higher-Speed Physical Layer Extension in the 2.4 GHz Band (approved Sep. 16, 1999; reaffirmed Jun. 12, 2003). Additional information regarding the IEEE 802.11e standard may be found in IEEE 802.11e Standard for Information technology—Telecommunications and information exchange between systems—Local and metropolitan area networks—Specific requirements Part 11: Wireless LAN Medium Access Control (MAC) and Physical Layer (PHY) specifications: Amendment 8: Medium Access Control (MAC) Quality of Service Enhancements (published 2005). Additional information regarding the IEEE 802.11g protocol standard may be found in IEEE std. 802.11 g™, IEEE Std 802.11 g™, IEEE Standard for Information technology—Telecommunications and information exchange between systems—Local and metropolitan area networks—Specific requirements Part 11: Wireless LAN Medium Access Control (MAC) and Physical Layer (PHY) specifications Amendment 4: Further Higher Data Rate Extension in the 2.4 GHz Band (approved Jun. 12, 2003). Additional information regarding the IEEE 802.16 protocol standard may be found in IEEE Standard for Local and Metropolitan Area Networks—Part 16: Air Interface for Fixed Broadband Wireless Access Systems (published Oct. 1, 2004).

Embodiments of the present invention may be implemented as part of any wired or wireless system. Examples may also include embodiments comprising multi-carrier wireless communication channels (e.g., orthogonal frequency division multiplexing (OFDM), discrete multitone (DMT), etc.) such as may be used within a wireless personal area network (WPAN), a wireless local area network (WLAN), a wireless metropolitan are network (WMAN), a wireless wide area network (WWAN), a cellular network, a third generation (3G) network, a fourth generation (4G) network, a universal mobile telephone system (UMTS), and like communication systems, without limitation.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. A method, including:
receiving an inbound wireless packet at a wireless network interface card (NIC) associated with a multi-partitioned computing platform, wherein the inbound wireless packet is formatted as a wireless distribution system (DS) packet containing a receiver address and a destination address;
converting the inbound wireless packet to an inbound Ethernet packet, wherein the inbound Ethernet packet is formatted to contain the destination address; and
sending at least one portion of the inbound Ethernet packet to a destination virtual machine (VM) partition corresponding to the destination address.

2. The method of claim 1, further including:
performing a look-up operation using a bridging table associated with a wireless bridge to determine which of a plurality of VM partitions associated with the multi-partitioned computing platform comprises the destination VM partition.

3. The method of claim 2, wherein the inbound wireless packet is converted to the inbound Ethernet packet using the wireless bridge.

4. The method of claim 2, wherein the at least one portion of the inbound Ethernet packet is sent from the wireless bridge to a destination Ethernet NIC driver associated with a destination network stack in the destination VM partition.

5. The method of claim 2, wherein the inbound wireless packet is received from a wireless access point (AP) communicatively coupled to a network, wherein the wireless AP is adapted to perform a look-up of the receiver address from a wireless bridging table associated with the wireless AP, and wherein the bridging table relates the receiver address to a plurality of destination addresses, each of the plurality of destination addresses corresponding to one of the plurality of VM partitions.

6. The method of claim 5, further including:
receiving at least one portion of an outbound Ethernet packet at the wireless bridge from an originating VM partition, wherein the at least one portion of the outbound Ethernet packet contains a source address corresponding to the originating VM partition and a destination address corresponding to a node on the network;
converting the outbound Ethernet packet to an outbound wireless packet, wherein the outbound wireless packet is formatted as a wireless DS packet containing a transmitter address corresponding to an address associated with the wireless NIC, a receiver address associated with the wireless AP, a source address corresponding to the originating VM partition, and a destination address corresponding to the node on the network; and
transmitting the outbound wireless packet from the wireless NIC to the wireless AP.

7. The method of claim 6, wherein the at least one portion of the outbound Ethernet packet is received at the wireless bridge from an originating Ethernet NIC driver associated with an originating network stack in the originating VM partition.

8. The method of claim 6, wherein the outbound Ethernet packet is converted to the outbound wireless packet using the wireless bridge.

9. An article including a machine-accessible medium having associated information, wherein the information, when accessed, results in a machine:
receiving an inbound wireless packet at a wireless network interface card (NIC) associated with a multi-partitioned computing platform, wherein the inbound wireless packet is formatted as a wireless distribution system (DS) packet containing a receiver address and a destination address;
converting the inbound wireless packet to an inbound Ethernet packet, wherein the inbound Ethernet packet is formatted to contain the destination address; and
sending at least one portion of the inbound Ethernet packet to a destination virtual machine (VM) partition corresponding to the destination address.

10. The article of claim 9, wherein the information, when accessed, results in a machine:
performing a look-up operation using a bridging table associated with a wireless bridge to determine which of a plurality of VM partitions associated with the multi-partitioned computing platform comprises the destination VM partition.

11. The article of claim 10, wherein the information, when accessed, results in a machine:
receiving at least one portion of an outbound Ethernet packet at a wireless NIC from an originating VM partition, wherein the outbound Ethernet packet contains a source address corresponding to the originating VM partition and a destination address corresponding to a node on the network;
converting the outbound Ethernet packet to an outbound wireless packet, wherein the outbound wireless packet is formatted as a wireless DS packet containing a transmitter address corresponding to an address associated with the wireless NIC, a receiver address associated with a wireless access point (AP), a source address corresponding to the originating VM partition, and a destination address corresponding to the node on the network; and
transmitting the outbound wireless packet from the wireless NIC to the wireless AP.

12. An apparatus, including:
a wireless media access control (MAC) module associated with a multi-partitioned computing platform, the wireless MAC module adapted to receive an inbound wireless packet formatted as a wireless distribution system packet, the inbound wireless packet containing a receiver address and a destination address; and
a wireless bridge coupled to the wireless MAC module to convert the inbound wireless packet to an inbound Ethernet packet formatted to contain the destination address and to send at least one portion of the inbound Ethernet packet to a destination virtual machine (VM) partition corresponding to the destination address.

13. The apparatus of claim 12, further including:
an Ethernet network interface card (NIC) emulator coupled to the wireless bridge and associated with the destination VM partition, the Ethernet NIC emulator to deliver the at least one portion of the inbound Ethernet packet to an Ethernet NIC driver associated with the destination VM partition.

14. The apparatus of claim 13, wherein a wireless NIC associated with the multi-partition computing platform comprises the wireless MAC module, the wireless bridge, and the Ethernet NIC emulator.

15. The apparatus of claim 13, further including:
a virtual machine monitor (VMM) coupled to at least one of the Ethernet NIC emulator or the wireless bridge to allocate Ethernet emulation resources to the destination VM partition.

16. The apparatus of claim 15, wherein the VMM comprises the wireless bridge and the Ethernet NIC emulator.

17. The apparatus of claim 16, wherein the VMM further comprises a wireless NIC emulator, the wireless NIC emulator coupled to a proxy wireless NIC driver associated with a primary VM partition to interface the primary VM partition to wireless structures within the VMM.

18. The apparatus of claim 12, further including:
a wireless network interface card (NIC) driver associated with a primary VM partition and coupled to the wireless MAC module, the wireless NIC driver to communicate at least one of data, status, or configuration parameters between the primary VM partition and the wireless MAC module.

19. An apparatus, including:
a wireless access point (AP) to communicatively couple to a wireless network interface card (NIC) associated with a multi-partitioned computing platform, the wireless AP to send an inbound wireless distribution system (DS) packet to the wireless NIC for delivery to a destination virtual machine (VM) associated with the multi-partitioned computing platform; and
a bridging module associated with the wireless AP to insert a receiver address into the inbound wireless DS packet, wherein the receiver address is associated with the wireless NIC.

20. The apparatus of claim 19, further including:
a bridging table coupled to the bridging module to associate the receiver address with a destination address contained in the inbound wireless DS packet, wherein the destination address is associated with the destination VM.

21. The apparatus of claim 20, wherein the inbound wireless DS packet is formatted according to an Institute of Electrical and Electronic Engineers 802.11 wireless protocol standard.

22. A system, including:
a wireless bridge associated with a multi-partitioned computing platform, the wireless bridge configured to receive an outbound Ethernet packet from an originating virtual machine (VM) partition and to convert the outbound Ethernet packet to an outbound wireless packet formatted as a wireless distribution system packet;
a wireless media access control (MAC) module coupled to the wireless bridge to send the outbound wireless packet to a wireless access point (AP) for delivery to a node on an external network; and
an omnidirectional antenna operatively coupled to the wireless MAC module.

23. The system of claim 22, further including:
a wireless network interface card (NIC) driver associated with a primary VM partition and coupled to the wireless MAC module, the wireless NIC driver to communicate at least one of data, status, or configuration parameters between the primary VM partition and the wireless MAC module.

24. The system of claim 23, further including:
a wireless connection manager associated with the primary VM partition and coupled to the wireless NIC driver to configure a wireless NIC containing the wireless MAC module and to receive and report status from the wireless NIC.

25. The system of claim 24, further including:
a security supplicant to couple to the wireless connection manager to exchange encryption keys with the wireless AP.
